(19) United States
(12) Patent Application Publication
(10) Pub. No.: US 2022/0300261 A1
(43) Pub. Date: Sep. 22, 2022

(54) DETERMINING IF A COMMIT IS PROBLEMATIC

(71) Applicants: Patrick Deziel, Eagan, MN (US); James M. Plasek, Eagan, MN (US); Rami Reddy Nelluru, Bengaluru Karnataka (IN); Kelsey L. Bruso, Eagan, MN (US)

(72) Inventors: Patrick Deziel, Eagan, MN (US); James M. Plasek, Eagan, MN (US); Rami Reddy Nelluru, Bengaluru Karnataka (IN); Kelsey L. Bruso, Eagan, MN (US)

(73) Assignee: Unisys Corporation, Blue Bell, PA (US)

(21) Appl. No.: 17/202,452

(22) Filed: Mar. 16, 2021

(51) Int. Cl. G06F 8/41; G06N 20/00; G06F 16/178

(52) U.S. Cl. CPC G06F 8/43; G06N 20/00; G06F 16/178; G06Q 10/101

(57) ABSTRACT

A method of determining if a commit is problematic includes determining a complexity of the commit; determining an author of the commit; determining an experience of the author; determining a component affected by the commit; and assigning a risk value to the commit based on the complexity, the author, the experience of the author and the component affected.

### FIELD OF THE DISCLOSURE

The present application relates generally to qualifying the impacts of third party code changes on dependent software, and in particular using a machine learning tool to predict the severity of any impact a given code change may have.

### BACKGROUND

Modern software products heavily depend on third party code. Updating to new versions of third-party software presents inherent risks, in terms of interface changes, performance impacts, runtime bugs and security vulnerabilities. Knowledge of these risks is necessary for evaluating whether or not to update to newer releases. For example, in large software systems if performance of the system degrades over time, a large manual effort is needed to track the performance regression down to the particular change, requiring a search of potentially thousands of updates in the repository. Large third party code repositories often have a high rate of changing code, resulting in dozens of upgrades per day. Thus, it is virtually impossible to manually vet every upgrade before it is made. Therefore improvements are desirable to reduce the risks of numerous upgrades to system stability, security, and performance.

### SUMMARY

In a first aspect of the present invention, a method for creating a learning model that evaluates risks of commits in an underlying native operating system to a non-native operating system is disclosed. The method includes collecting data on past commits; training the learning model using the collected data; and using the learning model to determine if future commits are problematic.

In another aspect of the present invention, a method of using a learning model to test commits from a third-party product into a dependent product includes receiving a commit from the third-party product; testing the commit using a pre-trained learning model; and determining if the commit is problematic, and if the commit is problematic, sending the commit for review before implementation and sending a report to a reviewer outlining the level of risk of implementing the commit and a reason for the level or risk.

In another aspect of the present invention, a method of testing commits from a third-party product into a dependent product includes receiving a first commit from a third-party product; waiting for additional commits from the third-party product; receiving a second commit from the third-party product; testing the first and second commit using a pre-trained learning model; determining if the first commit is problematic, and if the first commit is problematic, sending the first commit for review before implementation; and determining if the second commit is problematic, and if the second commit is problematic, sending the second commit for review before implementation.

In another aspect of the present invention, a method of determining if a commit is problematic includes determining a complexity of the commit; determining an author of the commit; determining an experience of the author, determining a component affected by the commit; and assigning a risk value to the commit based on the complexity, the author, the experience of the author and the component affected.

In another aspect of the present invention, a method of alerting an open source community to potential problematic commits includes receiving a commit submitted by an author in an open source project; testing the commit using a pre-trained learning model; and determining if the commit is problematic, and if the commit is problematic, sending a report in the open source project outlining the level of risk of implementing the commit and a reason for the level or risk.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the disclosed system and methods, reference is now made to the following descriptions taken in conjunction with the accompanying drawings.

FIG. 1 is a block diagram of a computing system having a non-native operating system operating over a native operating system in an emulated environment, according to one embodiment of the present invention;

FIG. 2 is a flow diagram of a method of creating a learning model that evaluates risks of commits in an underlying native operating system to a non-native operating system, according to one embodiment of the present invention;

FIG. 3 is a block diagram illustrating learning features;

FIG. 4 is a block diagram illustrating a computer network, according to one example embodiment of the present invention; and

FIG. 5 is a block diagram illustrating a computer system, according to one example embodiment of the present invention.

### DETAILED DESCRIPTION

Various embodiments of the present invention will be described in detail with reference to the drawings. Reference to various embodiments does not limit the scope of the invention, which is limited only by the scope of the claims attached hereto. Additionally, any examples set forth in this disclosure are not intended to be limiting and merely set forth some of the many possible embodiments for the claimed invention. The logical operations of the various embodiments of the disclosure described herein may be implemented as a sequence of computer implemented steps, operations or procedures running on a programmable circuit within a computer or within a directory system, database or compiler.

In general the present disclosure relates to qualifying the impacts of third party code changes on dependent software, and in particular using a machine learning tool to predict the severity of any impact a given code change may have. The present disclosure uses supervised learning to predict the severity of an impact from any given change to third-party software to a dependent product across at least the following categories: application programmer interface (API), performance, runtime bugs and security. Historical data are collected from a repository containing the third-party product. The data set includes several data points for each upgrade, or commit, such as the number of code lines added and removed, the total number of commits that the author has made before, and the component modified by the commit.

Using these features, for each commit, the data set is then tagged with low, medium or high for each category to indicate the level of risk of integrating that commit with the dependent software. A supervised learning algorithm is used to train a predictive model on the data set. This model is applied to future commits to estimate the level of risk of integrating each change. More generally, the model can be used to assess the risk of upgrading to a newer released version of the third-party software. The model can also be refined over time as more commits are integrated.

Execution of non-native instructions on a native computing system can be improved by using a just-in-time (JIT) compiler. The JIT compiler is away of executing computer code that involves compilation during execution of the program—at run time—rather than before execution. The JIT compiler improves system performance because only the code that needs to be compiled is compiled as it is needed. The JIT compiler also allows repeated sections of code to be compiled once and subsequently executed at a greater speed.

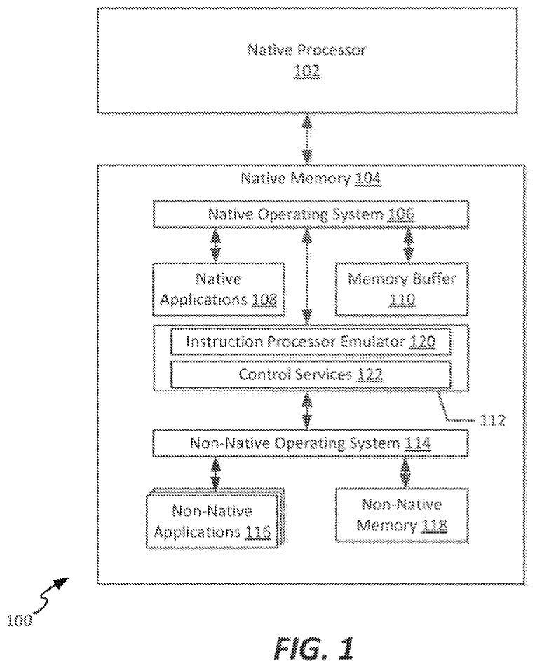

Referring now to FIG. 1, a logical block diagram of a computing system 100 is shown that can be used to execute non-native code using a JIT compiler. In other words, the computing system 100 includes hardware and software capable of retrieving non-native instructions (i.e., instructions that are not capable of native execution on a particular computing system's instruction set architecture) and translating those instructions for execution on that computing system's native instruction set architecture. In the embodiment shown, the computing system 100 includes a native instruction processor 102 communicatively connected to a native, physical memory 104.

In the embodiments discussed herein, the processor 102 is generally referred to as a native instruction processor, in that it is a programmable circuit configured to execute program instructions written in a particular, native instruction set architecture. In various examples, the instruction set architecture corresponds to an Intel-based instruction set architecture (e.g., IA32, IA32, IA64, x86, x86-64, etc.); however, other instruction set architectures could be used.

The memory 104 stores computer-executable instructions to be executed by the processor 102, which in the embodiment shown includes a native operating system 106, native applications 108, a memory buffer 110, and an emulated system 112 hosting one or more non-native components. The native operating system 106 is generally an operating system compiled to be executed using the native instruction set architecture of the processor 102, and in various embodiments discussed herein, can be a commodity-type operating system configured to execute on commodity hardware. Examples of such an operating system 106 include UNIX, LINUX, WINDOWS, or any other operating system adapted to operate on the Intel-based instruction set architecture processor 102.

The native applications 108 can be, for example, any of a variety of applications configured to be hosted by a native operating system 106 and executable on the processor 102 directly. Traditionally, applications 108 correspond to lower-security or lower-reliability applications for which mainframe systems were not traditionally employed. In such an arrangement, memory buffer 110 can be managed by the native operating system 106, and can store data for use in execution of either the native operating system 106 or the applications 108.

The one or more non-native components hosted by the emulated system 112 include a non-native operating system 114, which in turn manages non-native applications 116 and a non-native memory buffer 118. The non-native operating system 114 can be any of a variety of operating systems compiled for execution using an instruction set architecture other than that implemented in the processor 102, and preferably such that the non-native operating system and other non-native applications are incapable of natively (directly) executing on the processor 102. Any of a variety of emulated, non-native operating systems can be used, such that the emulated operating system is implemented using a non-native instruction set architecture. In one possible embodiment, the emulated operating system is the OS2200 operating system provided by Unisys Corporation of Blue Bell, PA. Other emulated operating systems could be used as well, but generally refer to operating systems of mainframe systems.

The non-native applications 116 can include, for example mainframe applications or other applications configured for execution on the non-native architecture corresponding to the non-native operating system 114. The non-native applications 116 and non-native operating system 114 are generally translated by the emulated system 112 for execution using the native instruction processor 102. In addition, non-native memory buffer 118 allows for management of data in the non-native applications 116 by the non-native operating system 114, and is an area in memory 104 allocated to a partition including the non-native operating system 114. The non-native memory buffer 118 generally stores banks of instructions to be executed, loaded on a bank-by-bank basis.

The emulated system 112 can be implemented, in some embodiments, as an executable program to be hosted by a native operating system 106. In an example embodiment, the emulated system 112 is configured as an executable hosted by a Linux operating system (the native operating system 106) dedicated to one Intel processor 102 implementing an Intel instruction set. The emulated system 112 also communicates to Linux for Input/output, memory management, and clock management services. In some embodiments, this emulated system 112 can be maintained on the computing system effectively as microcode, providing translation services for execution of the non-native instructions.

The emulated system 112 further includes an instruction processor emulator 120 and a control services component 122. The instruction processor emulator 120 generally appears to the non-native operating system 114 as an instruction processor configured to execute using the non-native instruction set architecture. The instruction processor emulator 120 is generally implemented in software, and is configured to provide a conduit between the non-native operating system 114 and non-native applications 116 and the native computing system formed by the instruction processor 102 and native operating system 106. In other words, the instruction processor emulator 120 determines which native instructions to be executed that correspond to the non-native instructions fetched from the instruction bank loaded. For instance, the emulator may include an interpretive emulated system that employs an interpreter to decode each legacy computer instruction, or groups of legacy instructions.

After one or more instructions are decoded in this manner, a call is made to one or more routines that are written in “native mode” instructions that are included in the instruction set of instruction processor 102. Such routines emulate each of the operations that would have been performed by the legacy system, and are collected into native code snippets that can be used in various combinations to implement native versions of the non-native instructions.

Another emulated approach utilizes a JIT compiler as part of the instruction processor emulator 120 to analyze the object code of non-native operating system 114 and thereby convert this code from the legacy instructions into a set of native code instructions that execute directly on processor 102, rather than using precompiled native code snippets. After this conversion is completed, the non-native operating system 114 then executes directly on the processor 102 without any run-time aid of the instruction processor emulator 120. These, and/or other types of emulation techniques may be used by the instruction processor emulator 120 to emulate non-native operating system 114 in an embodiment wherein that operating system is written using an instruction set other than that which is native to processor 102.

Taken together, the instruction processor emulator 120 and control services 122 provide the interface between the native operating system 106 and non-native operating system 114 such that non-native applications 116 can run on the native processor 102. For instance, when non-native operating system 114 makes a call for memory allocation, that call is made via the instruction processor emulator 120 to control services 122. Control services 122 translates the request into the format required by an API 124. The native operating system 106 receives the request and allocates the memory. An address to the memory is returned to control services 122, which then forwards the address, and in some cases, status, back to the non-native operating system 114 via the instruction processor emulator 120. In one embodiment, the returned address is a C pointer (a pointer in the C language) that points to a buffer in a virtual address space.

In one example embodiment the JIT compiler compiles code from the non-native operating system 114 into native code that can execute directly on the native processor 102 through the native operating system 106, the JIT compiler is dependent on the underlying native operating system 106 as well as the non-native operating system 114. Upgrades to either operating system 106, 114 can affect the JIT compiler significantly.

In this embodiment, the instruction processor emulator 120 (with the JIT compiler) uses the LLVM Project, which is an open source collection of modular and reusable compiler and toolchain technologies to perform just-in-time compilations. The instruction processor emulator 120 is thus heavily dependent on LLVM. Compilation time and execution time on the native processor 102 are indicators of LLVM's efficiency. The compilation time is the time it takes the JIT compiler to process a sequence of instructions into optimized native x86-64 assembly, which is bounded by LLVM. The execution time is the time it takes for the optimized x86-64 code to be executed on the native processor 102, which is a measure of how good LLVM was at optimizing the sequence of instructions for execution. An improvement to the execution time is usually accompanied with an increase in the compilation time, since it usually requires more processing by LLVM's optimization passes. Conversely, an improvement to the compilation time is usually accompanied by an increase in the execution time.

Upgrading (or committing) to newer releases of LLVM is a necessary lifecycle management task. This lifecycle management includes downloading and building new LLVM releases, responding to API changes in LLVM and testing for bugs and performance regressions. Any commit of LLVM and its potential impact on the instruction processor emulator 120 needs to be evaluated. As such, one example embodiment, a Buildbot is configured to automatically build, integrate, and test new LLVM commits immediately after they are published. This allows a response to LLVM bugs and performance regressions more quickly but at the expense of continuous CPU power usage.

A further improvement to the Buildbot is the use of machine learning to qualify the risks of moving to new LLVM releases. A large amount of historical data is available from multiple sources (GitHub, Bugzilla), so a machine learning model has numerous examples of bugs and performance regressions to draw and learn from. Second, LLVM has an active development trunk that has several commits per day. This amount of code chum allows the model to be refined over time as more commits are done.

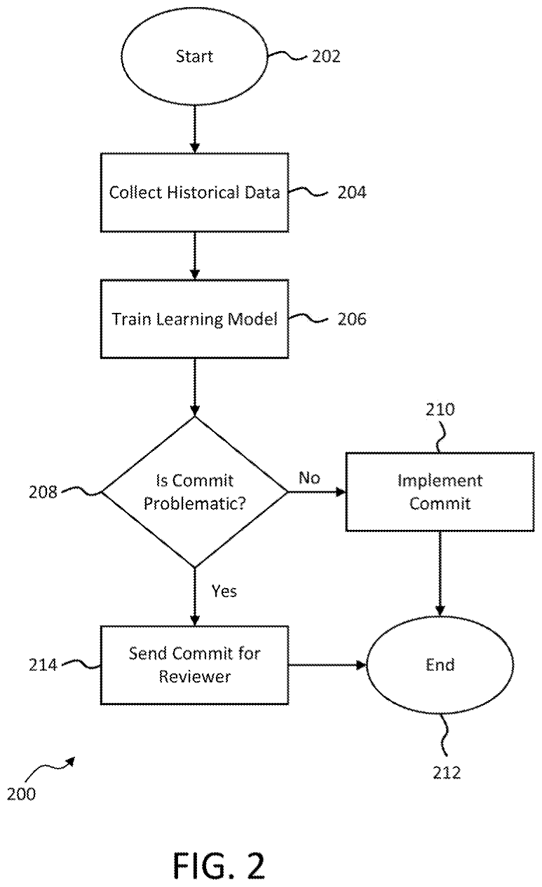

Referring to FIG. 2, a method 200 of determining if a commit is problematic using machine learning is illustrated, starting at 202. At 204, historical data on past commits is collected. In this example embodiment, because the LLVM project is open source, the entire commit history is available on GitHub. GitHub is used to collect data from the commits, comments and collaborators repositories and store it in formatted files. The LLVM community uses Bugzilla to document bugs. Unlike GitHub, there is no publicly available API upon which to request data. However, there is a distinct web page for each bug indexed by bug ID. So, a search functionality on the website is used to collect the list of bug IDs that corresponded to bugs that were reported in the same date range that were obtained from the commits. A script scrapes the HTML page for each bug and dumps the data to formatted files. The data is collected and includes attributes such as the bug title, the affected component, the date the bug was reported, the bug description, and user comments.

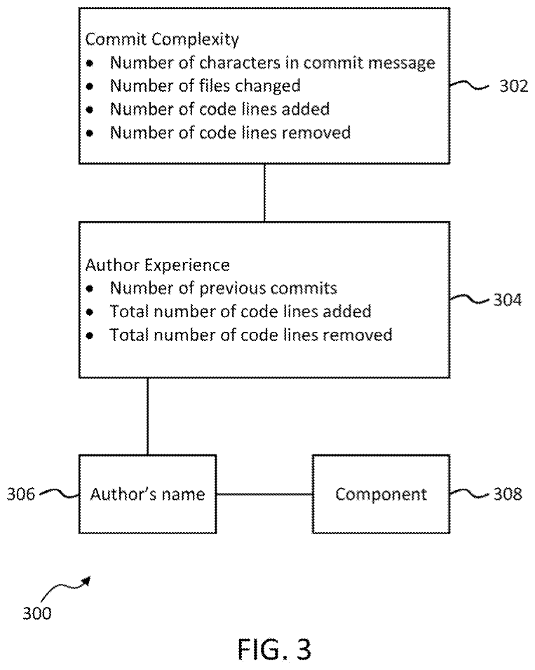

At 206, a learning model is created and trained on the historical data. After collecting the historical information, it is determined which data points are useful for predicting a negative impact to the instruction processor emulator 120. Referring to FIG. 3, in one example embodiment, data points 300 for predicting a negative impact to the instruction processor emulator 120 are illustrated. One factor is commit complexity 302. The more complex a commit is, the more likely it is for that commit to introduce unintended side effects to the JIT compiler. In this disclosure at least four measures of complexity that impacted performance were ascertained from the collected data: the number of characters in the commit message, the number of files changed, the number of code lines added, and the number of code lines removed. A second factor includes author experience 304. A commit author who has limited experience committing to the repository or modifying certain areas of the code could have a greater chance of introducing bugs or performance regressions. For purposes of this model, the following measures of author experience were used: the number of LLVM commits previously done by the author, the total number of code lines added at the time of the commit, and the total number of code lines removed at the time of the commit.

Two additional predictive features include: the name of the author 306 who did the commit (because different authors may have a different rate of making error prone commits) and the component 308 in which the commit is made (because certain LLVM components may be more prone to bugs or performance regressions than others). The present invention uses an algorithm to indicate the modified component for each commit.

The algorithm first inspects the commit message. If the first word is in brackets, the algorithm assumes it is the component name. Where there is not a bracketed component name, the algorithm checks the list of changed files. The file that has the greatest number of changed lines is assumed to be the main component that was changed. For example, suppose the algorithm were applied to changes to the product LLVM. If the file with the most changed lines was “llvm/lib/Analysis/InstructionSimplify.cpp”, the algorithm asserts the component to be “InstructionSimplify”. Of course, a single commit can modify multiple components, but most LLVM commits mainly focus on one component.

In order to utilize supervised machine learning techniques, the collected data set must be annotated. For each commit, the invention creates a categorization for the commit to indicate the level of risk that commit represents in terms of introducing bugs. The categorization may contain one of two values: ‘1’ if the commit introduced at least one bug and ‘0’ otherwise.

A commit message might contain the text “this reverts commit r345487”. This implies there was a problem with commit 345487, so that commit should be tagged as ‘1’ in the dataset. This gives a straightforward way to annotate the data set. For each commit message, if the text contains the string ‘revert’, or one of its synonyms, any mentioned revision numbers are extracted from the text and their commits in the data set are tagged with the value ‘1’. All other commits are tagged with ‘0’.

After annotating the data set, a linear classifier is used, leveraging the Tensorflow libraries in Python. This trains a model to predict whether or not a given LLVM commit presents a bug risk for the software that uses LLVM. In testing, the trained model accuracy was found to be 96.4% accurate at predicting problematic commits.

Predicting whether or not a code change has bugs is only one aspect of understanding the risk of upgrading to new versions of third-party software. The other part of the problem is understanding what parts of the dependent software, in this example it is a JIT compiler, are affected by a change. For example, if a change is made to LLVM's register allocator code, it is helpful from the JIT developer's perspective to know which parts of the JIT compiler are affected.

In one example embodiment, the JIT compiler source code was split into discrete areas and a script was written to iterate through all the source files in the JIT compiler. For each file, the script scans for the C-style comment block indicators (/*, */) and extracts the code between the comment blocks, ignoring those that are empty or space-filled. The script outputs a list of start and end line numbers for each source file, which represent the extracted code blocks. While this script was developed specifically for analyzing the JIT compiler source code, it could be applied to any software that makes use of C-style comment blocks.

The next step for this aspect of the problem is to link the code block sections in the JIT compiler to sections in the LLVM source code. A second script was written to scan the JIT compiler source files and search for matching keywords in the GitHub commit data. This data along with the use of static code analysis techniques predict which parts of the JIT compiler are affected by a particular change to LLVM. The classification of the keywords, keyword names, and frequency of their occurrences also gives input to machine learning algorithms, such as linear discriminant analysis or logistic regression, to predict the risk of LLVM code changes to the JIT compiler.

Referring back to FIG. 2, at 208, the teaming model is used to determine if a commit is problematic. For each commit, the learning model can assign a level of risk, such as low, medium or high. An enterprise can then use this model to allocate resources to vetting future commits. For example, if the risk of a future commit is low, an enterprise can decide to automatically implement the commit without spending any resources. If the risk is high, an enterprise could assign it to an engineer to vet the commit before implementing it. Furthermore, the learning model can generate a report of the level of risk and the reason(s) why the level of risk is high, for example, by citing to the factors of FIG. 3. The report could go to the reviewer to help aid in the review. The report could also be sent back to an author of the commit in order to give a chance for the author to rewrite the commit and reduce the level of risk of the commit. In the open source project, the learning model could issue reports alerting the community of the level or risk and/or the reason(s), place tags on commits, or send reports to authors in order to give them a chance to rewrite the commit and reduce the level of risk.

If the learning model determines the commit is not problematic, flow branches “NO” to 210 to implement the commit and flow ends at 212. In the example of LLVM, implementing the commit can also include simply copying a pre-built version of the library rather than applying changes to an existing library. If the learning model determines the commit is problematic, flow branches “YES” to 214. The commit is sent for further review, for example by an engineer, and flow ends at 212. By sending the commit for further review at 214, performance, stability, security, and other potential problems can be reduced. By implementing non problematic commits at 210, manual vetting by an engineer can be reduced.

In addition to vetting changes in a third-party product for inclusion into a dependent product, shown in these examples as including LLVM into a JIT compiler, the results of the model also apply to the development of the third-party product itself. The model identifies areas where particular focus may be applied during the development, review, and testing process of the third-party product to increase its level of stability, robustness, security, performance, and so on.

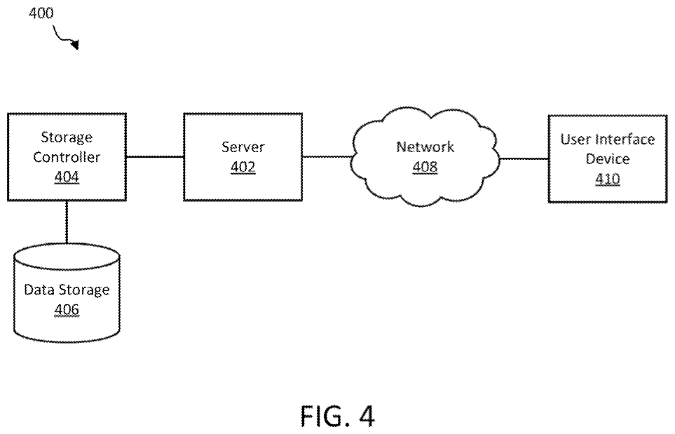

FIG. 4 illustrates one embodiment of a system 400 for an information system, which may host virtual machines. The system 400 may include a server 402, a data storage device 406, a network 408, and a user interface device 410. The server 402 may be a dedicated server or one server in a cloud computing system. The server 402 may also be a hypervisor-based system executing one or more guest partitions. The user interface device 410 may be, for example, a mobile device operated by a tenant administrator. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone or other a mobile communication device having access to the network 408. The user interface device 410 may be used to access a web service executing on the server 402. When the device 410 is a mobile device, sensors (not shown), such as a camera or accelerometer, may be embedded in the device 410. When the device 410 is a desktop computer the sensors may be embedded in an attachment (not shown) to the device 410. In a further embodiment, the user interface device 410 may access the Internet or other wide area or local area network to access a web application or web service hosted by the server 402 and provide a user interface for enabling a user to enter or receive information.

The network 408 may facilitate communications of data, such as dynamic license request messages, between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 410 accesses the server 402 through an intermediate sever (not shown). For example, in a cloud application the user interface device 410 may access an application server. The application server may fulfill requests from the user interface device 410 by accessing a database management system (DBMS). In this embodiment, the user interface device 410 may be a computer or phone executing a Java application making requests to a JBOSS server executing on a Linux server, which fulfills the requests by accessing a relational database management system (RDMS) on a mainframe server.

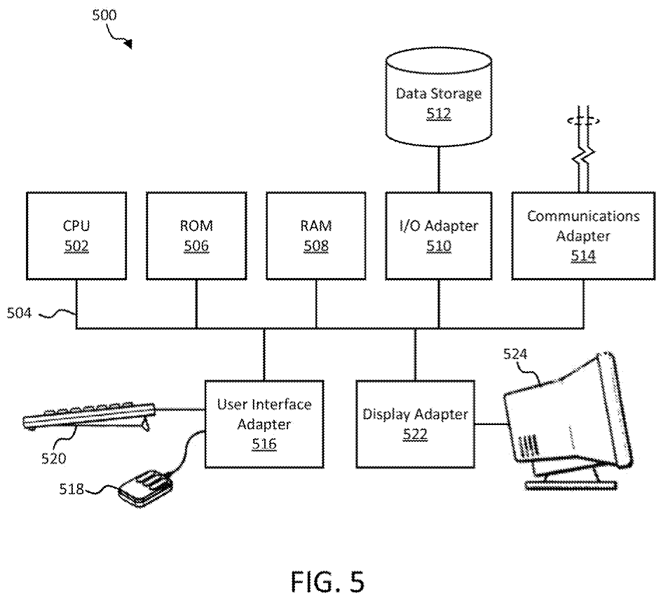

FIG. 5 illustrates a computer system 500 adapted according to certain embodiments of the server 402 and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 also may include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 508, which may be one or more of a LAN, WAN, and/or the Internet. The communications adapter 514 may also be adapted to couple the computer system 500 to other networks such as a global positioning system (GPS) or a Bluetooth network. The user interface adapter 516 couples user input devices, such as a keyboard 520, a pointing device 518, and/or a touch screen (not shown) to the computer system 500. The keyboard 520 may be an on-screen keyboard displayed on a touch panel. Additional devices (not shown) such as a camera, microphone, video camera, accelerometer, compass, and or gyroscope may be coupled to the user interface adapter 516. The display adapter 522 may be driven by the CPU 502 to control the display on the display device 524. Any of the devices 502-522 may be physical and/or logical.

The applications of the present disclosure are not limited to the architecture of computer system 500. Rather the computer system 500 is provided as an example of one type of computing device that may be adapted to perform the functions of a server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 500 may be virtualized for access by multiple users and/or applications. The applications could also be performed in a serverless environment, such as the cloud.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. A serverless environment, such as the cloud, could also be used.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. A serverless environment, such as the cloud, could also be used.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

We claim:

1. A method of determining if a commit is problematic, the method comprising:
determining a complexity of the commit;
determining an author of the commit;
determining an experience of the author;
determining a component affected by the commit; and
assigning a risk value to the commit based on the complexity, the author, the experience of the author and the component affected.

2. The method of claim 1, further comprising if the risk value is high, sending the commit for review before implementation.

3. The method of claim 2, further comprising, if the risk is low, implementing the commit.

4. The method of claim 3, wherein implementing the future commit includes copying a pre-built version of the library rather than applying changes to an existing library.

5. The method of claim 2, further comprising sending the commit for review before implementation.

6. The method of claim 5, further comprising sending a report to a reviewer outlining a level of risk of implementing the commit.

7. The method of claim 6, further comprising sending a report that includes a reason for the level or risk.

8. The method of claim 1, wherein the complexity includes a number of characters in a commit message, a number of file changed, a number of code lines added and a number of code lines removed.

9. The method of claim 1, wherein the experience of the author includes a number of previous commits, a total number of code lines added, and a total number of code lines removed.

10. The method of claim 1, further including:
determining, by a pre-trained learning model, a complexity of the commit;
determining, by a pre-trained learning model, an author of the commit;
determining, by a pre-trained learning model, an experience of the author;
determining, by a pre-trained learning model, a component affected by the commit; and
assigning a risk value to the commit, by a pre-trained learning model, based on the complexity, the author, the experience of the author and the component affected.

11. A non-transitory machine readable memory medium including instructions when executed to cause a processor to perform the following actions:
determining a complexity of the commit;
determining an author of the commit;
determining an experience of the author;
determining a component affected by the commit; and
assigning a risk value to the commit based on the complexity, the author, the experience of the author and the component affected.

12. The non-transitory machine readable memory medium of claim 11, further comprising if the risk value is high, sending the commit for review before implementation.

13. The non-transitory machine readable memory medium of claim 12, further comprising, if the risk is low, implementing the commit.

14. The non-transitory machine readable memory medium of claim 13, wherein implementing the future commit includes copying a pre-built version of the library rather than applying changes to an existing library.

15. The non-transitory machine readable memory medium of claim 12, further comprising sending the commit for review before implementation.

16. The non-transitory machine readable memory medium of claim 15, further comprising sending a report to a reviewer outlining a level of risk of implementing the commit.

17. The non-transitory machine readable memory medium of claim 16, further comprising sending a report that includes a reason for the level or risk.

18. The non-transitory machine readable memory medium of claim 11, wherein the complexity includes a number of characters in a commit message, a number of file changed, a number of code lines added and a number of code lines removed.

19. The non-transitory machine readable memory medium of claim 11, wherein the experience of the author includes a number of previous commits, a total number of code lines added, and a total number of code lines removed.

20. The non-transitory machine readable memory medium of claim 11, further including:
determining, by a pre-trained learning model, a complexity of the commit;
determining, by a pre-trained learning model, an author of the commit;
determining, by a pre-trained learning model, an experience of the author;
determining, by a pre-trained learning model, a component affected by the commit; and
assigning a risk value to the commit, by a pre-trained learning model, based on the complexity, the author, the experience of the author and the component affected.
